(19) United States
(12) Patent Application Publication
(10) Pub. No.: US 2014/0359193 A1
(43) Pub. Date: Dec. 4, 2014

(54) INTERFACE TRANSMISSION DEVICE

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: MENG-LIANG YANG, Shenzhen (CN); YANG LIU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/288,889

(22) Filed: May 28, 2014

(30) Foreign Application Priority Data
May 31, 2013 (CN) 2013102123586

(51) Int. Cl. G06F 13/40

(52) U.S. Cl. CPC G06F 13/4022
USPC 710/316

(57) ABSTRACT

An interface transmission device includes a controller, a principal connector, a plurality of subordinate connectors, and a plurality of switches with same numbers as those of the subordinate connectors. Each switch is connected to a subordinate connector. A logical address of each switch is different. The controller can exchange data with a PCIE card through the principal connector, or through one of the subordinate connectors according to a logical address of a switch.

### FIELD

The present disclosure relates to interface transmission devices.

### BACKGROUND

A plurality of peripheral component interconnect express (PCIE) interfaces connecting a plurality of PCIE cards are arranged on the motherboard of an electronic device, for improving the processing ability of the electronic device.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an interface transmission device.

FIGS. 2 and 3 are circuit diagrams of the interface transmission device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The phrase “a plurality of” means “at least two.”

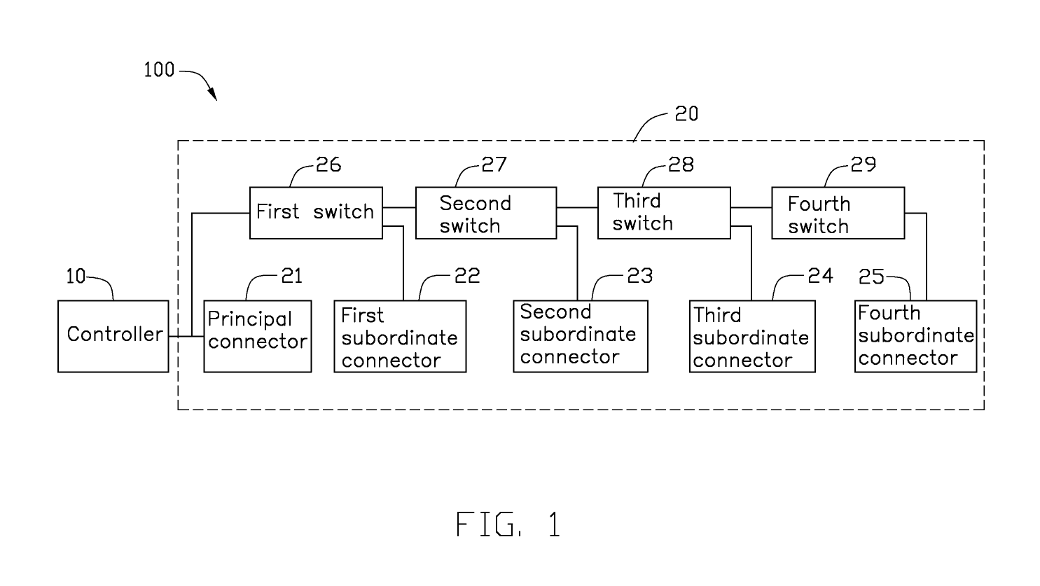

FIG. 1 shows an embodiment of an interface transmission device 100 for connecting a plurality of function cards which includes a controller 10 and a connecting unit 20 connected to the controller 10. In this embodiment, the connecting unit 20 includes a principal connector 21, first to fourth subordinate connectors 22-25, and first to fourth switches 26-29 respectively connected to the subordinate connectors 22-25. The first switch 26 is connected to the controller 10. The first to fourth switches 26-29 are connected in sequence. In this embodiment, each of the principal connectors 21 and first to fourth subordinate connectors 22-25 is a peripheral component interconnect express (PCIE) interface. The controller 10 is a platform controller hub (PCH).

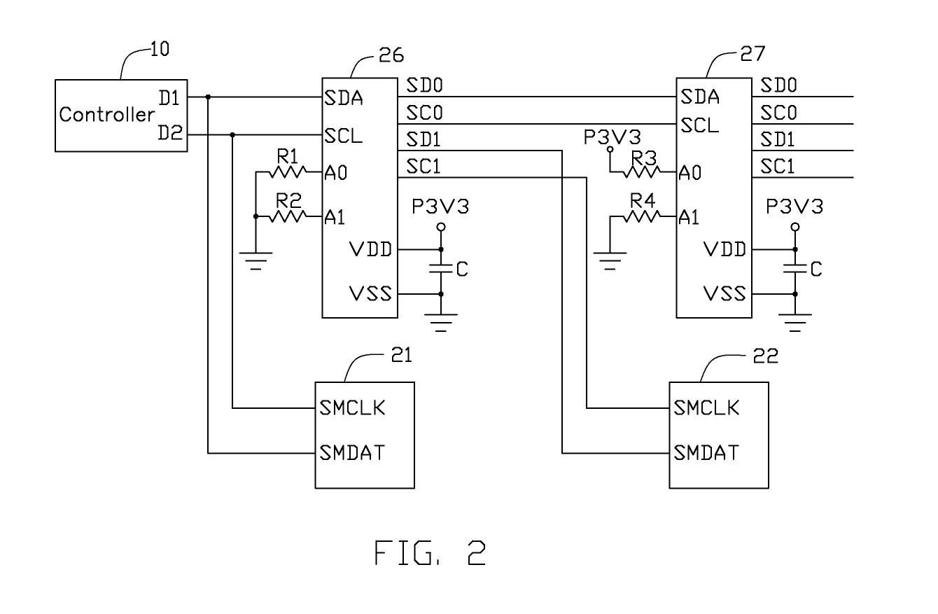

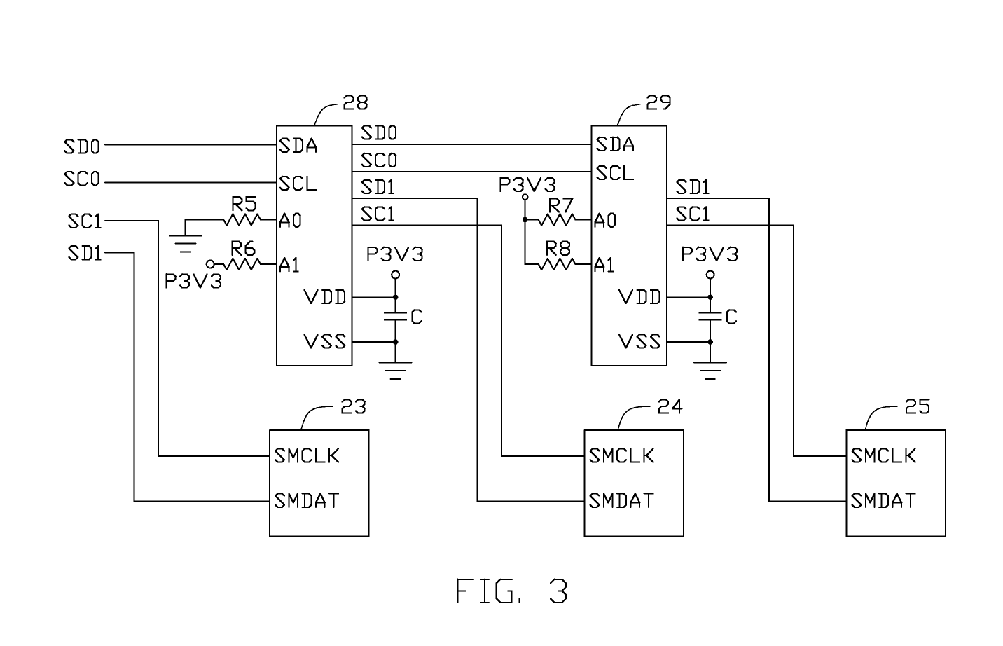

Referring to FIG. 2, the controller 10 includes a first data pin D1 and a second data pin D2. Each of the first to fourth switches 26-29 includes a first address pin A0, a second address pin A1, a first power pin VDD, a second power pin VSS, and first to sixth data pins SDA, SCL, SD1, SC1, SD0, SC0. Each of the subordinate connectors 22-25 includes a first data pin SMDAT and a second data pin SMCLK. The first data pin D1 of the controller 10 is connected to the first data pin SDA of the first switch 26, and also connected to the first data pin SMDAT of the principal connector 21. The second data pin D2 of the controller 10 is connected to the second data pin SCL of the first switch 26, and also connected to the second data pin SMCLK of the principal connector 21. The third data pin SD1 of the first switch 26 is connected to the first data pin SMDAT of the first subordinate connector 22. The fourth data pin SC1 of the first switch 26 is connected to the second data pin SMCLK of the first subordinate connector 22. The fifth data pin SD0 of the first switch 26 is connected to the first data pin SDA of the second switch 27. The sixth data pin SC0 of the first switch 26 is connected to the second data pin SCL of the second switch 27.

The third data pin SD1 of the second switch 27 is connected to the first data pin SMDAT of the second subordinate connector 23. The fourth data pin SC1 of the second switch 27 is connected to the second data pin SMCLK of the second subordinate connector 23. The fifth data pin SD0 of the second switch 27 is connected to the first data pin SDA of the third switch 28. The sixth data pin SC0 of the second switch 27 is connected to the second data pin SCL of the third switch 28.

The third data pin SD1 of the third switch 28 is connected to the first data pin SMDAT of the third subordinate connector 24. The fourth data pin SC1 of the third switch 28 is connected to the second data pin SMCLK of the third subordinate connector 24. The fifth data pin SD0 of the third switch 28 is connected to first data pin SDA of the fourth switch 29. The sixth data pin SC0 of the third switch 28 is connected to the second data pin SCL of the fourth switch 29.

The third data pin SD1 of the fourth switch 29 is connected to first data pin SMDAT of the fourth subordinate connector 25. The fourth data pin SC1 of the third switch 28 is connected to the second data pin SMCLK of the fourth subordinate connector 25.

In this embodiment, the first power pin VDD of each of the first to fourth switches 26-29 is connected to a power source P3V3, and is grounded through a capacitor C. The second power pin VSS of each of the first to fourth switches 26-29 is grounded.

The first and second address pins A0, A1 of the first switch 26 are grounded through resistor R1 and resistor R2 respectively. The first address pin A0 of the second switch 27 is connected to the power source P3V3 through a resistor R3. The second address pin A1 of the second switch 27 is grounded through a resistor R4. The first address pin A0 of the third switch 28 is grounded through a resistor R5. The second address pin A1 of the third switch 28 is connected to the power source P3V3 through a resistor R6. The first and second address pins A0, A1 of the fourth switch 29 are connected to the power source P3V3 through a resistor R7 and a resistor R8 respectively. Each of the first to fourth switches 26-29 has a logical address assigned by a user. The logical address of each switch is an unique serial number to identify the switch in the interface transmission device 100. The logic addresses of the first to fourth switches 26-29 are set as 00, 01, 10, and 11 respectively and correspond to the first to fourth subordinate connectors 22-25 respectively.

In use, when the controller 10 initializes, the first data pin SDA is connected to the third data pin SD1 of each of the switches 26-29. The second data pin SCL is connected to the fourth data pin SC1 of each of the switches 26-29. The controller 10 gets the logical address of each of the subordinate connectors 22-25 through each of the switches 26-29.

When the principal connector 21 is connected to a PCIE card, the controller 10 can exchange data with the PCIE card. When each of the first and second subordinate connectors 22, 23 is connected to a PCIE card, the controller 10 gets the logical addresses 00, 01 from the first and second switches 26, 27, for selecting an object subordinate connector according to the logical addresses 00, 01.

When the controller 10 sends a logical address code “00,” the first switch 26 receives the logical address code “00” and determines whether the logical address code “00” received is the same as the logical address of the first switch 26. When the logical address code “00” received from the controller 10 is found to be the same as the logical address of the first switch 26, the first data pin SDA of the first switch 26 is selectively connected to the third data pin SD1 of the first switch 26, instead of to the fifth data pin SD0. The second data pin SCL of the first switch 26 is selectively connected to the fourth data pin SC1 of the first switch 26, instead of to the sixth data pin SC0 of the first switch 26. The controller 10 can exchange data with the PCIE card connected to the first subordinate connector 22, through the third data pin SD1, and the fourth data pin SC1 of the first switch 26.

When the controller 10 sends a logical address code “01,” the first switch 26 receives the logical address code “01” and determines whether the logical address code “01” received is the same as the logical address of the first switch 26. If the logical address code “01” received from the controller 10 is different from the logical address of the first switch 26, the first data pin SDA of the first switch 26 is selectively connected to the fifth data pin SD0 of the first switch 26 instead of to the third data pin SD1 of the first switch 26. The second data pin SCL of the first switch 26 is selectively connected to the sixth data pin SC0 of the first switch 26 instead of to the fourth data pin SC1 of the first switch 26. The first switch 26 transmits the logical address code “01” to the first data pin SDA and the second data pin SCL of the second switch 27, through the fifth data pin SD0 and the sixth data pin SC0 of the first switch 26. The second switch 27 determines whether the logical address code “01” received from the first switch 26 is the same as the logical address of the second switch 27. If the logical address code “01” received from the first switch 26 is the same as the logical address of the second switch 27, the first data pin SDA of the second switch 27 is selectively connected to the third data pin SD1 of the second switch 27, instead of to the fifth data pin SD0 of the second switch 27. The second data pin SCL of the second switch 27 is selectively connected to the fourth data pin SC1 of the second switch 27, instead of to the sixth data pin SC0 of the second switch 27. The controller 10 can exchange data with the PCIE card connected to the second subordinate connector 23, through the third data pin SD1 and the fourth data pin SC1 of the second switch 27.

Similarly, when the controller 10 transmits data with the PCIE card connected to the third subordinate connector 24 or to the fourth subordinate connector 25, the operation principle is the same principle as applying to the controller 10 exchanging data with the PCIE card connected to the second subordinate connector 23.

The controller 10 can transmit data with a PCIE card connected to a subordinate connector according to a logical address of a switch connected to the subordinate connector.

In other embodiments, the number of the subordinate connectors and the switches is adjusted according to the number of the address pins of the switch. If the number of the address pins of the switch is N, the number of the subordinate connectors and the switches is less than or equal to two to the power of N.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An interface transmission device comprising a controller and a connecting unit, the connecting unit comprising:
a principal connector comprising a first data pin and a second data pin;
a first subordinate connector; and
a first switch comprising a first data pin, a second data pin, a third data pin, a fourth data pin, and a plurality address pins for setting a logical address of the first subordinate connector;
wherein a first data pin and a second data pin of the controller are connected to the first and second data pins of the principal connector respectively, to make the controller communicate with the principal connector through the first and second data pins of the principal connector; the third and fourth data pins of the first switch are connected to the first subordinate connector; and
wherein when the first subordinate connector is selected by the controller through the address set by the first switch, the first data pin of the first switch is connected to the third data pin of the first switch, the second data pin of the first switch is connected to the fourth data pin of the first switch, and the controller communicates with the first subordinate connector through the first and second data pins of the first switch.

2. The interface transmission device of claim 1, further comprising a second subordinate connector and a second switch, wherein the first switch further comprises fifth and sixth data pins, the second switch comprises a first data pin, a second data pin, a third data pin, a fourth data pin, and a plurality of address pins for setting a logical address of the second subordinate connector; the fifth data pin of the first switch is connected to the first data pin of the second switch, the sixth data pin of the first switch is connected to the second data pin of the second switch, the third and fourth data pins of the second switch are connected to the second subordinate connector; when the second subordinate connector is selected by the controller by sending an address which is the same as the address of the second switch, the first data pin of the first switch is connected to the fifth data pin of the first switch, the second data pin of the first switch is connected to the sixth data pin of the first switch, the first data pin of the second switch is connected to the third data pin of the second switch, and the second data pin of the second switch is connected to the fourth data pin of the second switch.

3. The interface transmission device of claim 2, wherein each of the first and second switches comprises first and second address pins, the first and second address pins of the first switch are grounded, the first address pin of the second switch is connected to a power source, and the second address pin of the second switch is grounded.

4. The interface transmission device of claim 3, wherein a first power pin of each of the first and second switches is connected to the power source, and also connected to a second power pin of each of the first and second switches through a corresponding capacitor, and the second power pin of each of the first and second switches is grounded.

5. The interface transmission device of claim 3, wherein the controller is a platform controller hub.
